(19) United States
(12) Patent Application Publication
(10) Pub. No.: US 2025/0084552 A1
(43) Pub. Date: Mar. 13, 2025

(54) ELECTROLYSIS SYSTEM HAVING AN AUXILIARY ION EXCHANGER

(71) Applicant: Siemens Energy Global GmbH & Co. KG, München (DE)

(72) Inventors: Alexander Tremel, Möhrendorf (DE); Du-Fhan Choi, Düsseldorf (DE); Markus Ungerer, Baiersdorf (DE)

(21) Appl. No.: 18/567,797

(22) PCT Filed: Apr. 25, 2022
(86) PCT No.: PCT/EP2022/060811

§ 371 Date: Dec. 7, 2023

(30) Foreign Application Priority Data
Jun. 25, 2021 (EP) 21181820.8

(51) Int. Cl. C25B 15/08; C25B 1/04; C25B 9/19; C25B 9/70

(52) U.S. Cl. CPC C25B 15/085; C25B 1/04; C25B 9/19; C25B 9/70; C25B 15/087

(57) ABSTRACT

The invention relates to an electrolysis system having a plurality of electrolytic cells for water electrolysis. An anode-side water circuit leads from an anode-side outlet, via an oxygen separator, a main pump and a cooling device, to an anode-side inlet of an anode chamber. A cathode-side water circuit leads, similarly, from a cathode-side outlet, via an oxygen separator, a main pump and a cooling device, to a cathode-side inlet of a cathode chamber. Cleaning of the water during non-operation of the electrolysis system is achieved by adding an anode-side partial-flow branch, which leads from a branch-off point, via an auxiliary ion exchanger, to a collection point in the anode-side water circuit.

### BACKGROUND

The invention relates to an electrolysis system for electrochemical decomposition of water to generate hydrogen and oxygen comprising multiple electrolytic cells, wherein an anode-side water circuit and a cathode-side water circuit for removal of the gases and cooling of the water are present. The purity of the water is ensured by means of ion exchangers.

Various designs of electrolysis systems are known from the prior art. In any case, such an electrolysis system comprises an electrolyzer. In turn, various designs are used for this purpose, with a so-called PEM electrolyzer being commonly used. It comprises a plurality of electrolytic cells which are divided by a polymer electrolyte membrane into an anode chamber and a cathode chamber. What takes place in the electrolytic cells is water electrolysis, an inlet being present for this purpose at least on the anode chamber. Present on the top of the anode chamber and on the top of the cathode chamber is an outlet, via which the gas formed is removed in each case with an amount of water.

On an anode side, there is usually a water circuit from the outlet of the anode chamber to the inlet on the anode chamber, comprising an oxygen separator, a circulating pump, a cooling device and a filter arrangement. In order to ensure sufficient purity of the water, an ion exchanger is used in many cases in the anode-side water circuit.

Even though the known designs have been used successfully, one problem that has been found is that the ion exchanger, receiving the full flow in the water circuit, must be dimensioned larger than is necessary for cleaning of the water.

### SUMMARY

Embodiments include an electrolysis system for electrochemical generation of hydrogen and oxygen. The electrolysis system includes multiple electrolytic cells, each of which include an anode chamber containing an anode and, on an opposite side separated by a membrane, a cathode chamber containing a cathode, where a voltage can be applied as intended between anode and cathode. The electrolysis system also includes an anode-side water circuit which runs from an anode-side outlet to an anode-side inlet of the anode chambers and includes an oxygen separator and a main pump and a cooling device. The electrolysis system further includes an anode-side substream branch which runs from a branch-off point to a collection point in the anode-side water circuit and includes an auxiliary ion exchanger, where the branch-off point is arranged downstream of the main pump and the cooling device and upstream of the anode-side inlet of the anode chambers in the direction of flow. The collection point is arranged downstream of the anode-side outlet of the anode chambers and upstream of the oxygen separator in the direction of flow.

### BRIEF DESCRIPTION OF THE FIGURES

Various example arrangements of an electrolysis system according to the invention are delineated in the following figures, where:

FIG. 1 shows a first exemplary embodiment of an electrolysis system according to the invention comprising a cross-stream connection between the two separators;

FIG. 2 shows a second exemplary embodiment of an electrolysis system according to the invention in which a cleaning branch is dispensed with; and

FIG. 3 shows a third exemplary embodiment of an electrolysis system according to the invention comprising a cross-stream connection from the cleaning branch to the oxygen separator.

### DETAILED DESCRIPTION

An object of the invention is to ensure the purity of the water even during nonoperation of the electrolyzer, while keeping the complexity of cleaning low.

The electrolysis system of the type in question serves for electrochemical decomposition of water and thus for generation of hydrogen and oxygen. The electrolysis system comprises at least one electrolysis unit. The electrolysis unit in turn comprises multiple electrolytic cells. Each individual electrolytic cell has an anode chamber and, on an opposite side separated by a membrane, a cathode chamber. The type of membrane here is immaterial, though preference is given to using a polymer electrolyte membrane. Present in the anode chamber is an anode and present oppositely in the cathode chamber is a cathode. During operation of the electrolysis system, a voltage is applied as intended between the anode and the cathode.

To perform the method, it is necessary to supply water to the electrolytic cell. Furthermore, it is necessary to ensure that the gases formed are discharged separately. To this end, the electrolysis system comprises an anode-side water circuit. It starts at an anode-side outlet of the anode chamber and runs via an oxygen separator, a main pump and a cooling device back to an anode-side inlet on the anode chamber. The order of the elements is immaterial, and it also immaterial whether further devices are present in the water circuit.

During the operation of the electrolysis system, what generically takes place on the cathode side is discharge of the hydrogen formed, together with an amount of water, from a cathode-side outlet on the cathode chamber toward a hydrogen separator. To this end, preference is given to using analogously a cathode-side water circuit in which a main pump and a cooling device are additionally present. Here, the cathode-side water circuit runs toward a cathode-side inlet of the cathode chamber.

Now, in order to be able to ensure the purity of the water during stoppage times of the electrolysis system and also to limit the complexity of installation of an ion exchanger, the invention uses an anode-side substream branch with an auxiliary ion exchanger arranged therein. The anode-side substream branch starts at a branch-off point in the anode-side water circuit and returns to a collection point in the anode-side water circuit.

Here, the branch-off point on the anode-side water circuit is positioned downstream of the arrangement comprising the separator, the main pump and the cooling device and upstream of the anode-side inlet of the anode chambers of the electrolytic cells in the direction of flow of the anode-side water circuit.

According to the invention, a cleaning stream through the electrolytic cells without flow through the separator is realized by positioning the collection point downstream of the anode-side output of the anode chambers of the electrolytic cells in the direction of flow and upstream of the separator in the direction of flow of the anode-side water circuit.

This allows a shortened circuit through the electrolytic cell and the substream branch comprising the auxiliary ion exchanger without the need for flow through the separator, the main pump and the cooling device in the anode-side water circuit.

The embodiment according to the invention with an auxiliary ion exchanger in the substream branch allows cleaning of the water, or deionization, without a configuration for the entire water stream being necessary. In particular, this arrangement allows the use of the auxiliary ion exchanger with the substream branch even when the electrolysis system is otherwise not in use.

In one embodiment, an analogous arrangement on the cathode side. Accordingly, the electrolysis system comprises a cathode-side substream branch which runs from a branch-off point in the cathode-side water circuit to a collection point in the cathode-side water circuit via an auxiliary ion exchanger.

If no reference is made to the anode side or the cathode side hereinafter, the same applies to both the anode side and the cathode side. However, it is not necessary for both sides to be of identical design. Rather, it is also possible to provide two different embodiments for the anode side and the cathode side.

In order to allow flow through the electrolytic cells and the auxiliary ion exchanger during nonoperation of the electrolysis system, a substream pump is arranged in the substream branch.

During regular operation of the electrolysis system, water of the anode-side water circuit flows through the anode chambers from the inlet thereof to the outlet thereof and, separately, water of the cathode-side water circuit flows through the cathode chambers from the inlet thereof to the outlet thereof.

For effective maintenance of the purity of the water during nonoperation, particular preference is given to the anode-side substream pump bringing about flow from the anode-side output to the anode-side input of the anode chambers and to the cathode-side substream pump bringing about flow from the cathode-side output to the cathode-side input of the cathode chambers.

Furthermore, the arrangement of an auxiliary ion exchanger in the substream branch connected to the water circuit also allows the use thereof during operation of the electrolysis system. To this end, if a substream pump is present, a bypass switchable by means of valves is present, so that flow through the substream branch is possible without operation of the substream pump.

Owing to the advantageous embodiment of the electrolysis system, the maintenance of the purity of the water can be achieved just with the auxiliary ion exchanger even during operation of the electrolysis system. In one embodiment, the flow through the substream branch is parallel to the electrolytic cell, and so the water circuit only has to be configured according to the flow.

In a further embodiment, an additional cleaning branch is connected to the water circuit. Arranged in the cleaning branch is a main ion exchanger. Here, a certain portion of the water in the water circuit is guided through the cleaning branch. Here, since only a portion of the water flowing in the water circuit flows through the cleaning branch, dimensioning is reduced to this smaller amount, thereby reducing the complexity of installation.

In one embodiment, the two ends of the cleaning branch are connected to the separator. The connection should be made in such a way that the oxygen or hydrogen has already been discharged from the water coming from the separator.

In another embodiment, the water can be discharged from the water circuit into the cleaning branch downstream of the separator in the direction of flow. This means that a first end of the cleaning branch starts at the water circuit downstream of the separator. The second end of the cleaning branch can in turn be connected to the separator. Accordingly, circulation through the separator and the main ion exchanger is also brought about here.

Furthermore, the return path of the deionized water from the cleaning branch into the water circuit can be made upstream of the separator. This means that the second end of the cleaning loop is connected to the water circuit upstream of the separator in the direction of flow.

If the first end of the cleaning branch should be connected to the separator, a cleaning pump is necessary in any case in the cleaning branch, thus allowing circulation from the separator, through the main ion exchanger in the cleaning branch, and directly or indirectly back to the separator.

Furthermore, a cooling device is disposed in the cleaning branch and the cooling device can positively influence the performance of the main ion exchanger. The cooling device is situated between the cleaning pump and the main ion exchanger.

In another embodiment, a cleaning pump is not necessary in order to bring about flow through the cleaning branch. Nevertheless, the water is circulated from the separator and back into the separator. To this end, it is necessary to arrange a branch-off point from the water circuit downstream of the main pump in the direction of flow. The other end of the cleaning branch in turn is directly connected to the separator or connected to the water circuit upstream of the separator. Accordingly, what is brought about here is circulation through the main ion exchanger by the main pump.

In this case, it is likewise advantageous if a cooling device is present upstream of the main ion exchanger in the direction of flow. To this end, the branch-off point to the cleaning branch can be arranged in the water circuit downstream of the cooling device in the direction of flow, and so a separate cooling device in the cleaning branch is not necessary.

In one embodiment, circulation of the water can be avoided by flow through the cleaning branch sectionally parallel to the water circuit. Here, a first end of the cleaning branch is situated on an output of the separator or on the water circuit downstream of the separator in the direction of flow.

To ensure sufficient flow through the main ion exchanger sectionally parallel to the water circuit, a cleaning pump in turn can be provided. In contrast, where the merging with the water circuit occurs is of minor importance. However, what appears to be suitable is an arrangement of a second end of the cleaning branch into the water circuit downstream of the main pump and downstream of the cooling device in the water circuit in the direction of flow.

In this case, it may also be advantageous to arrange a cooling device in the cleaning branch upstream of the main ion exchanger in the direction of flow.

In principle, the water circulating in the water circuit and through the electrolyzer should be free of particles of any kind. However, in order to prevent particles liberated from the elements flowed through from settling in the anode chamber and in the cathode chamber, it is furthermore particularly advantageous to use one or more filter devices. A filter device can be arranged directly in the water circuit and/or in the substream branch and/or in the cleaning branch. It is particularly advantageous if a filter device is present downstream of each ion exchanger in the direction of flow or at least upstream of the inlet of the anode chamber and upstream of the inlet of the cathode chamber.

Here, it should be clearly noted again that it is not necessary for the anode side to be of identical design to the cathode side.

Owing to the process, water generally passes over from the anode chamber into the cathode chamber. In order to allow the water to be returned from the cathode side to the anode side, a cross-stream connection is particularly advantageously present. Various implementation options are available.

Irrespective of the chosen method for connecting on the cathode side, it is in any case advantageous if the cross-stream connection runs toward the oxygen separator of the anode-side water circuit.

In a first embodiment, the cross-stream connection runs from the cathode-side water circuit to the anode-side water circuit. It is particularly advantageous if the cross-stream connection branches off from the hydrogen separator of the cathode-side water circuit.

In a second embodiment, the cross-stream connection runs from the cathode-side substream branch to the anode-side water circuit. It is particularly advantageous if the cross-stream connection branches off somewhere downstream of the auxiliary ion exchanger.

In a third embodiment, the cross-stream connection starts at the cathode-side cleaning branch. Just as above, it is particularly advantageous if the branch-off point is arranged downstream of the main ion exchanger.

Particularly in the first embodiment, but also usable in the other two embodiment, a cross-stream ion exchanger and a cross-stream pump are advantageously arranged in the cross-stream connection. As a result, the return flow from the cathode side to the anode side of the water that has passed over can be actively brought about and the purity of the water can be ensured at the same time.

Furthermore, in this case, a cooling device and/or a filter device is/are advantageously present in the cross-stream connection.

In contrast, an ion exchanger and a pump in the cross-stream connection is not absolute necessary in the second embodiment and the third embodiment, since the substream branch or the cleaning branch (depending on the design) already contains an ion exchanger (which is also why the branch-off point is arranged downstream). Also, the necessary flow in the cross-stream connection can be brought about just by the flow in the substream branch or the cleaning branch that is brought about by a respective pump.

The possible arrangements of an electrolysis system according to the invention are schematically delineated in the following figures, with identical, recurring elements being assigned the same reference sign. Furthermore, an electrolysis system generally comprises one or more electrolyzers, each in turn comprising multiple electrolytic cells comprising a corresponding anode chamber and cathode chamber. An electrolytic cell is delineated merely symbolically in the illustrations. The structure of an electrolyzer and the electrolytic cell will not be discussed here.

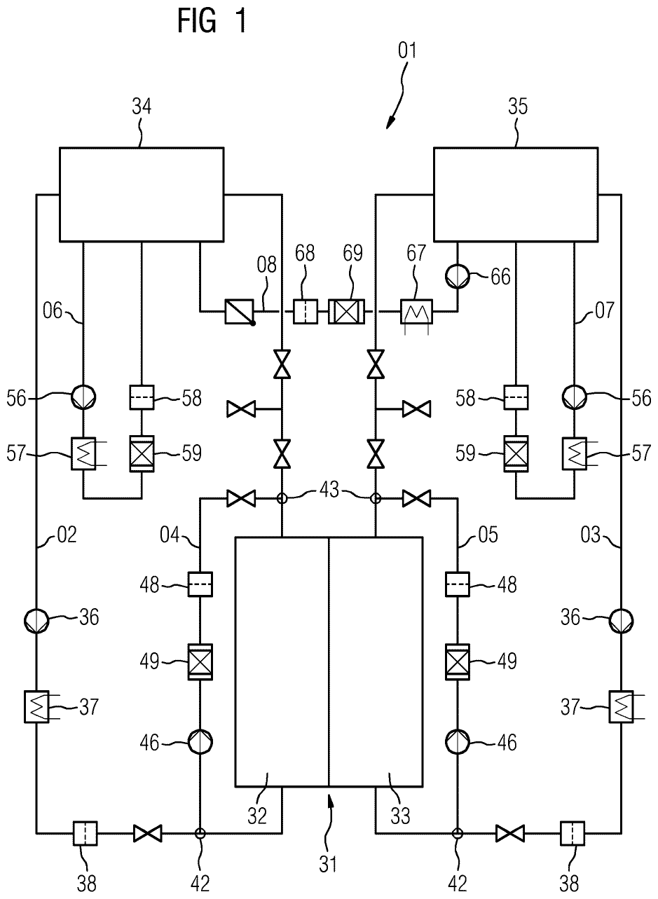

Now, FIG. 1 illustrates a first exemplary embodiment of an electrolysis system 01. It 01 comprises as an essential element the electrolytic cell 31, which 31 comprises an anode chamber 32 and a cathode chamber 33.

Connected to the anode chamber 32 is an anode-side water circuit 02 which 02 starts at an outlet of the anode chamber 32 and runs via an oxygen separator 34. Furthermore, present in the water circuit 02 are a main pump 36 and a cooling device 37. Furthermore, arranged between it 37 and an inlet on the anode chamber 32 is a filter device 38 in the water circuit 02.

The cathode side has an analogous structure comprising a cathode-side water circuit 03 connected to the cathode chamber 33. Accordingly, it 03 analogously starts at an outlet of the cathode chamber 33 and runs toward a hydrogen separator 35. Likewise, present downstream in the water circuit 03 in the direction of flow are a main pump 36, a cooling device 37 and a filter device 38, before the water circuit 03 ends at the inlet of the cathode chamber 33.

What is essential to the invention, irrespective of the specific design, is the arrangement of an auxiliary ion exchanger 49 in an anode-side substream branch 04 and/or in a cathode-side substream branch 05. The two ends of the substream branch 04, 05—a branch-off point 42 and a collection point 43—are connected to the respective water circuit 02, 03.

As can be seen in the illustration, present on one side of the substream branch 04, 05 between the branch-off point 42 and the collection point 43 is the electrolytic cell 31. In contrast, arranged on the other side of the substream branch 04, 05 are the respective separator 34, 35 and the main pump 36, the cooling device 37 and the filter device 38 in the respective water circuit 02, 03.

It is an object of the invention to allow cleaning of the water even during stoppage of the electrolysis system, during which the electrolytic cells are not under voltage. To this end, a substream pump 46 is further arranged in the substream branch 04, 05. In addition, a filter device 48 is additionally used.

This arrangement allows, firstly, circulation of the water in the water circuit 02 from and to the anode chambers 32 and circulation of the water in the water circuit 03 from and to the cathode chambers 33 during operation of the electrolysis system 01.

Now, if the electrolysis system 01 is not in operation, i.e., the electrolytic cells 31 are not supplied with electricity, the main pump 36 can be switched off and circulation can be brought about via the substream branch 04, 05 by means of the respective substream pump 46 with deionization in the auxiliary ion exchanger 49. Accordingly, the purity of the water can be ensured even over prolonged periods of stoppage of the electrolysis system 01.

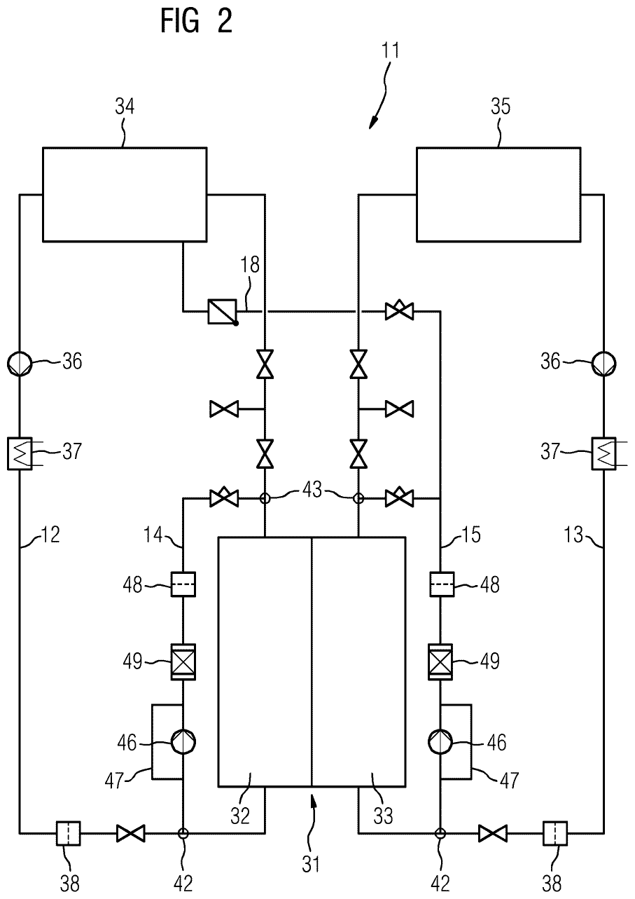

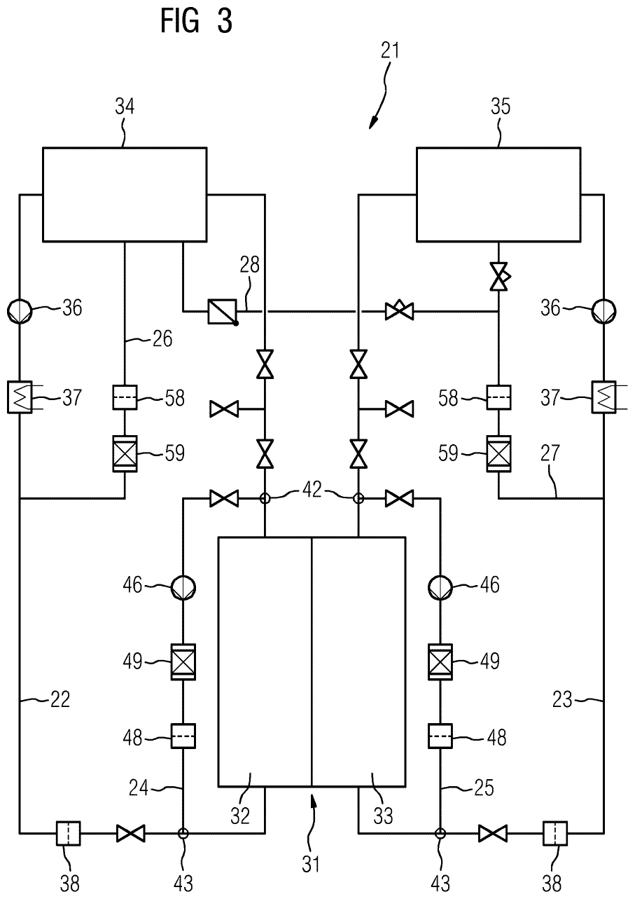

The anode-side water circuit 02 and cathode-side water circuit 03 delineated in FIG. 1, starting from the anode chamber 32 and the cathode chamber 33, respectively, and running via the separator 34,35, the main pump 36, the cooling device 37 and the filter device 38, likewise recur in the following embodiments from FIG. 2 and FIG. 3.

Furthermore, also present in the two further exemplary embodiments in FIGS. 2 and 3 are the substream branch 04 comprising the substream pump 46 and the auxiliary ion exchanger 49 and connected to the water circuit 02, and the substream branch 05 comprising the substream pump 46 and the auxiliary ion exchanger 49 and connected to the water circuit 03.

In the design from FIG. 1, the substream branch 04, 05 is only flowed through for cleaning when main pump 36 is switched off. In this case, since no gas is evolved, the anode chamber 32 and the cathode chamber 33 are flowed through in the opposition direction compared to the usual direction of flow during operation of the electrolysis system 01.

In order to ensure the water quality on both sides during operation of the system, this embodiment proposes connecting a cleaning branch 06 to the separator 34 and connecting a cleaning branch 07 to the separator 35. The anode-side cleaning loop 06 runs from the oxygen separator 34, via a cleaning pump 56 and a cooling device 57, through a main ion exchanger 59, and lastly through a filter device 58 and back to the oxygen separator 34.

The cathode side in this example has an analogous structure comprising a cathode-side cleaning branch 07 which starts at the hydrogen separator 35 and runs via the main pump 56 and the cooling device 57, through the main ion exchanger 59 and the filter device 58 and back to the hydrogen separator 35. Consequently, there is circulation out of and into the separator 34 and circulation out of and into the separator 35.

Furthermore, it can be seen in the illustration that, in this exemplary embodiment, a cross-stream connection 08 from the hydrogen separator 35 to the oxygen separator 34 is present. Arranged in the cross-stream connection 08 are a cross-stream pump 66, a cooling device 67, and a cross-stream ion exchanger 69 and a filter device 68.

In contrast, the design from FIG. 2 shows itself to be much simpler. Here, an additional cleaning branch is dispensed with. In order to be able to ensure deionization during operation of the electrolysis system 11 here as well, use is made of the substream branch 14, 15 comprising the respective auxiliary ion exchanger 49. In this case, since the respective main pump 36 brings about the circulation in the water circuit 12, 13 during operation, there is additionally provided a bypass 47 around substream pump 46. It is obvious that valves at least in the bypass (not shown) are necessary to switch between the states of operation of the electrolysis system 11 with flow through the water circuit 12, 13 and of nonoperation with circulation only through the substream branch 14 and the anode chamber 32 and through the substream branch 15 and the cathode chamber 33.

A further distinguishing feature in relation to the preceding design is that a cross-stream connection 18 from the cathode-side substream branch 15 to the oxygen separator 34 is provided in the exemplary embodiment in FIG. 2. Purity is already ensured by the branch-off point downstream of the auxiliary ion exchanger 49, and so a further ion exchanger is not necessary in the cross-stream connection 18.

In the example design from FIG. 3, likewise present are the water circuit 22 connected to the anode chamber 32 of the electrolytic cell 31 and comprising the oxygen separator 34, the main pump 36, the cooling device 37 and the filter device 38, and the water circuit 23 connected to the cathode chamber 33 of the electrolytic cell 31 and comprising the hydrogen separator 35, the main pump 36, the cooling device 37 and filter device 38.

Likewise present as essential to the invention are the substream branch 24 on the anode side which 24 runs from a branch-off point 42 to a collection point 43 in the water circuit 22, and the substream branch 25 on the cathode side which 25 runs from a branch-off point 42 to a collection point 43 in the water circuit 23. The order of the elements from the branch-off point 42 to the collection point 43 is in line with the previous examples chosen with the substream pump 46, the auxiliary ion exchanger 49 and the filter device 48.

However, in contrast to the previous examples, provided here is an opposite direction of flow in the substream branch 24, 25. Accordingly, the branch-off point 42 is present between the outlet on the anode chamber 32 and the oxygen separator 34 and between the outlet on the cathode chamber 33 and the hydrogen separator 35. The collection point 43 is accordingly arranged upstream of the inlet. The anode chamber 32 is effected in the same direction both during operation of the electrolysis system 21 with circulation through the water circuit 22 and during nonoperation with circulation through the substream branch 24, and the cathode chamber 33 is effected in the same direction both during operation of the electrolysis system 21 with circulation through the water circuit 23 and during nonoperation with circulation through the substream branch 25.

Similar to the first example from FIG. 1, a cleaning branch 26, 27 is present here as well in this example in FIG. 3. However, by changing the connection to the water circuit 22, 23, there is no need for a cleaning pump and an additional cooling device in the cleaning branch 26, 27. To this end, the cleaning branch 26, 27 is connected to the water circuit 22, 23 downstream of the main pump 36 and the cooling device 37. Present in the cleaning branch 26, 27 are the main ion exchanger 59 and a filter device 58. In line with the example from FIG. 1, the anode-side cleaning branch 26 returns to the oxygen separator 34 and the cathode-side cleaning branch 27 returns to the hydrogen separator 35 in this design of the electrolysis system 21.

In this case, a cross-stream connection 28 is connected to the cathode-side cleaning branch 27, the branch-off point being arranged downstream of the main ion exchanger 59 and the filter device 58. As a result, there is no need to arrange an ion exchanger in the cross-stream connection 28. In line with the previous examples, connection of the cross-stream connection 28 to the oxygen separator 34 allows the water that passes over to be returned into the anode-side water circuit 22.

1. An electrolysis system for electrochemical generation of hydrogen and oxygen, comprising:
multiple electrolytic cells, each of which comprises an anode chamber containing an anode and, on an opposite side separated by a membrane, a cathode chamber containing a cathode, wherein a voltage can be applied as intended between anode and cathode; and
an anode-side water circuit which runs from an anode-side outlet to an anode-side inlet of the anode chambers and comprises an oxygen separator and a main pump and a cooling device; and
an anode-side substream branch which runs from a branch-off point to a collection point in the anode-side water circuit and comprises an auxiliary ion exchanger, wherein the branch-off point is arranged downstream of the main pump and the cooling device and upstream of the anode-side inlet of the anode chambers in the direction of flow; characterized in that the collection point is arranged downstream of the anode-side outlet of the anode chambers and upstream of the oxygen separator in the direction of flow.

2. The electrolysis system as claimed in claim 1, further comprising:
a cathode-side water circuit which runs from a cathode-side outlet to a cathode-side inlet of the cathode chambers and comprises a hydrogen separator and a main pump and a cooling device; and
a cathode-side substream branch which runs from a branch-off point to a collection point in the cathode-side water circuit and comprises an auxiliary ion exchanger,
wherein the branch-off point is arranged downstream of the main pump and the cooling device and upstream of the cathode-side inlet of the cathode chambers in the direction of flow,
wherein the collection point is arranged downstream of the cathode-side outlet of the anode chambers and upstream of the hydrogen separator in the direction of flow.

3. The electrolysis system as claimed in claim 1,
wherein a substream pump is arranged in the anode-side substream branch; and/or
wherein a substream pump is arranged in the cathode-side substream branch.

4. The electrolysis system as claimed in claim 3,
wherein the substream pump brings about flow from the anode-side output to the anode-side input of the anode chamber during stoppage of electrolysis; and/or
wherein the substream pump brings about flow from the cathode-side output to the cathode-side input of the cathode chamber during stoppage of electrolysis.

5. The electrolysis system as claimed in claim 3,
wherein the anode-side substream branch comprises a switchable bypass around the substream pump; and/or
wherein the cathode-side substream branch comprises a switchable bypass around the substream pump.

6. The electrolysis system as claimed in claim 1,
wherein a cleaning branch comprising a main ion exchanger is connected to the anode-side water circuit; and/or
wherein a cleaning branch comprising a main ion exchanger is connected to the cathode-side water circuit.

7. The electrolysis system as claimed in claim 6,
wherein the cleaning branch comprises a cleaning pump and a cooling device.

8. The electrolysis system as claimed in claim 6,
wherein a first end of the cleaning branch is connected to an output of the separator or to the water circuit downstream of the separator in the direction of flow.

9. The electrolysis system as claimed in claim 8,
wherein the second end of the cleaning branch is connected to an input of the separator or to the water circuit upstream of the separator in the direction of flow, wherein circulation from the separator and back into the separator takes place during operation.

10. The electrolysis system as claimed in claim 8,
wherein the second end of the cleaning branch is connected to the water circuit downstream of the first end in the direction of flow, wherein a partial amount from the water circuit is guided sectionally parallel to the water circuit during operation.

11. The electrolysis system as claimed in claim 1, wherein a cross-stream connection from the cathode-side water circuit or from the cathode-side substream branch or from the cathode-side cleaning branch to the anode-side water circuit is present.

12. The electrolysis system as claimed in claim 11, wherein the cross-stream connection runs toward the oxygen separator.

13. The electrolysis system as claimed in claim 11,
wherein the cross-stream connection branches off from the hydrogen separator; or
wherein the cross-stream connection branches off from the cathode-side substream branch downstream of the auxiliary ion exchanger in the direction of flow; or
wherein the cross-stream connection branches off from the cathode-side cleaning branch downstream of the main ion exchanger in the direction of flow.

14. The electrolysis system as claimed in claim 11, wherein a cross-stream ion exchanger and a cross-stream pump and a cooling device are arranged in the cross-stream connection.

15. The electrolysis system as claimed in claim 1, wherein a filter device is arranged in the water circuit and/or in the substream branch and/or in the cleaning branch and/or in the cross-stream connection.
